(19) United States
(12) Patent Application Publication
(10) Pub. No.: US 2017/0161724 A1
(43) Pub. Date: Jun. 8, 2017

(54) RADIO FREQUENCY IDENTIFICATION CARD AND MOBILE PHONE INTERLINKING EMBEDDED ELECTRONIC PAYMENT APPARATUS AND METHODS

(71) Applicant: Uniway Technology Limited, Kowloon (HK)

(72) Inventor: Vincent Hon Kwong Lau, Kowloon (HK)

(21) Appl. No.: 15/369,721

(22) Filed: Dec. 5, 2016

(30) Foreign Application Priority Data
Dec. 5, 2015 (CN) 201510894642.5

(51) Int. Cl. G06Q 20/34; G06Q 20/40; G08B 21/18; G06Q 20/38

(52) U.S. Cl. CPC G06Q 20/353; G06Q 20/3829; G06Q 20/405; G08B 21/182; H04W 4/008

(57) ABSTRACT

An apparatus and methods for renewing payment based on interlinking of radio frequency identification cards, mobile phones with electronic payment apparatuses implemented as embedded devices. The application supports service fee payment and remote renewal payments, as well as real-time collection of the security and environmental information relating to the electronic payment apparatus. A network of the electronic payment apparatuses can be used to implement Internet of Things and to form part of the information and communication technology infrastructure of a smart city. The collection of the foregoing security and environmental information would facilitate the implementation of a smart city that uses innovative solutions to address issues in one or more aspects of the city including governance, economy, mobility, environment, living and people, thereby improving the quality of life of the citizens and enhancing the sustainable growth and competitiveness of the city.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 C.F.R. §1.57.

### CROSS-REFERENCE TO RELATED APPLICATIONS

This application claims foreign priority under 35 U.S.C. §119 to Chinese Patent Application No. 201510894642.5 filed on Dec. 5, 2015, which is hereby incorporated by reference in its entirety.

### FIELD

Some embodiments relate to the management of electronic payment card driven payment service, and more particularly, to the use of embedded system technology and radio frequency identification technology in an electronic payment management system to perform payment and to renew payment for a specified service through an embedded electronic payment apparatus which is interlinking with a radio frequency identification card or a mobile phone.

### BACKGROUND

At present, the common service terminal apparatuses, such as laundry service, rental of goods, rental of venue and parking system, generally use a contactless IC card type electronic timer automatic payment charging apparatus, and charge according to service time, the user purchase a designated smart card in advance, and then uses the smart card to pay service charges, when the amount of money in the smart card is used up, the smart card shall be recharged and then be used to pay the service charges, however, since the payment charging apparatuses are generally located in different places, if the user's balance is not enough or has used up, it is not easy to find a store to recharge it, and when the service time of the service terminal apparatus is expired or time-out, it is necessary to go to the payment charging apparatus in person and pay the fees, so that the related services can be used continuously, so it is very troublesome.

In terms of management, a large number of patrol staff is required to check the operation conditions, penalty fees, maintenance and so on, and also manually collects the payment information from each service terminal apparatus one by one, and then aggregates them to a central terminal for clearance processing, the labor costs are still high, and is not as fast as the communication transmission system in terms of time, thus it is a very time-consuming and labor-intensive work.

Although IC card payment apparatus solves some of the management problems of the manual fee collection system, but it is difficult to be employed in large scale, and it can't carry out real-time statistic and status monitoring: limited by costs, the current IC card payment apparatus generally does not have the functions of real-time networking and communication. The operation staffs generally use a dedicated handheld data acquisition apparatus to collect transaction data locally in a short range distance by means of wireless communication, check the working status of the payment apparatus, and acquire the fee charging data collectively, and analyze the using status of different regions afterwards. It has heavy workload, and relatively high costs for labor, equipment and clearance.

Because the payment transaction data is stored in the internal memory of the payment apparatus, the loss or the electrical damage of the payment apparatus will result in the loss of the transaction data, resulting in certain amount of economic losses and even causing a security risk of the key system. The operation and maintenance costs of the equipment are high, and the structure of IC card apparatus is complex, and hence the hardware costs for the cards and card readers are high; the power consumption of the product is high, and the costs of construction and maintenance are high due to electricity wiring or frequently replacement of batteries and other vulnerable interface components; currently, the trend of the latest payment charging system is to allow the user to pay by credit card using his/her mobile phone.

In addition, regarding the benefits of using the service terminal apparatus, since currently a large number of charging equipment systems can't provide their information on the usage status to the management information center, thus the information center can't provide the status information of a service terminal apparatus to the user looking for the service terminal apparatus, and hence the user can only take the chance to look around, which will take a lot of time.

In view of the above, it can be seen that there are many disadvantages in the time-based fee-payment apparatus of the current service terminal apparatus, which is not in line with the trend of modern smart city construction for an information-oriented society which emphasizes efficiency, effectiveness and convenience.

### SUMMARY

This application discloses, in some embodiments, apparatus and methods for renewing payment based on interlinking of radio frequency identification cards, mobile phones with electronic payment apparatuses implemented as embedded devices. The application further discloses an electronic payment apparatus for performing payment and renewing payment remotely to a service terminal. The electronic payment apparatus can, in some embodiments be characterized by controlling and operating real-time supervision and management of all embedded firmware modules; managing and storing the information of the consumers' first-time used payment cards, renewal payment card, renewal payment apparatus, renewal payment phone number and email account; recording and processing charging rules; confirming charging payment after checking with blacklists; and establishing communication interlinking between the consumer's mobile phone and issuing real-time renewal instructions in order to carry out remote renewal payments. Finally, by using a terminal and an embedded encryption key to carry out mutual authentication and encryption of transaction record, real-time transaction record comprehensive backup can be performed. The whole record backup can be uploaded to the central payment operation control platform for checking and auditing, and thereafter sent to the settlement institution for payment clearance.

The application provides, in some aspects, a radio frequency identification card and smart phone interlinking embedded renewing apparatus and methods thereof, wherein the embedded central processor can be used to: control, execute and manage all embedded installed firmware module units; comprising any number of the following: a registration management unit, a key input unit, a charging management unit, an information management unit, a blacklist management unit, a transaction management unit, a security management unit, a security and environment management unit, a radio frequency identification reading and writing unit, a main record unit, a storage management unit, a communication management unit, an monitoring engine unit, a management service unit, an operation notification unit and a hybrid power system management unit.

Advantageously, in some embodiments, the key input unit further comprises an operation subunit and a mode key subunit.

Advantageously, in some embodiments, the charging management unit further comprises a first payment charging rule subunit and a service charging subunit.

Advantageously, in some embodiments, the information management unit further comprises an apparatus display subunit and a mobile phone communication setup interlinking subunit.

Advantageously, in some embodiments, the security management unit further comprises a secure access module (SAM) decryption key storage subunit, an embedded encryption and decryption key storage subunit, an advanced encryption standard (AES) decryption algorithm subunit and an AES encryption algorithm subunit.

Advantageously, in some embodiments, the security and environmental management unit further comprises a light sensor subunit, a tilt sensor subunit, a vibration sensor subunit, a temperature and humidity sensors subunit and other peripheral sensor subunit.

Advantageously, in some embodiments, the radio frequency identification reading and writing unit further comprises a debit card server payment application subunit, a credit card server payment application subunit and a prepaid card server payment application subunit.

Advantageously, in some embodiments, the main record unit further comprises a transaction record subunit, an operation record subunit, and a maintenance record subunit.

Advantageously, in some embodiments, the storage management unit further comprises a real-time comprehensive backup subunit and a whole set upload record backup subunit.

Advantageously, in some embodiments, the communication management unit further comprises a 3G/4G operation subunit, a Zigbee short-range wireless network subunit, a WiFi operation support subunit and a Bluetooth operation support subunit, an electronic receipt generating subunit, a service information reading subunit, an overtime penalty ticket generating subunit, and a dial-up operation subunit.

Advantageously, in some embodiments, the monitoring engine unit further comprises a module operation state reporting unit and an automatic repairing unit.

Advantageously, in some embodiments, the management service unit further comprises an upgrading unit, a reporting unit, a parameter setting unit and an extract download data subunit.

Advantageously, in some embodiments, the operation notification unit further comprises a sound notification subunit, a flashing notification subunit and a display control unit.

Advantageously, in some embodiments, the hybrid power system management unit further comprises a battery pack state of charge subunit, a battery operation subunit, and a backup rechargeable battery power supply subunit.

According to one aspect, an electronic payment system based on interlinking of a radio frequency identification card and mobile phone with an electronic payment apparatus is provided, which comprises in some embodiments any number of the following features:

an electronic payment apparatus operable in offline independent mode or network-connected mode, wherein the electronic payment apparatus simultaneously supports a plurality of sets of service terminals;
an electronic payment card driven payment platform;
a central payment operation control platform;
a clearance unit;
a remote audit unit;
a handheld data collection means;
a hardware security encryption and decryption unit;
a secured wireless communication unit;
a key management unit, through the secured wireless communication unit to input and output communication to perform radio frequency identification card driven payment service and to collect relevant data for central management;

The electronic payment apparatus comprises a security and environmental management unit for protecting all data stored in the electronic payment apparatus, for automatically triggering a theft alarm in response to security incidents, and for notifying the central payment operation control platform the security incidents, wherein the security and environmental management unit comprises any combinations of the following:

a) a light sensor subunit, for destroying security data stored in the electronic payment apparatus and triggering an alarm in response to unauthorized opening of an external cover of the electronic payment apparatus;

b) a tilt sensor subunit, for anti-theft and mechanical impact detection of the electronic payment apparatus, wherein the tilt sensor will trigger an alarm when the electronic payment apparatus tilts beyond a preset angular degree;

c) a vibration sensor subunit, for abnormal vibration detection, the vibration sensor will trigger an alarm when the electronic payment apparatus is hit and disrupted;

d) a temperature and humidity sensor subunit, for measuring the temperature and humidity, wherein the temperature and humidity sensor subunit is configured to report measurements regularly and send alerts automatically when temperature or humidity exceeds preset values, and wherein the temperature and humidity sensor subunit also triggers to operate a cooling fan in the electronic payment apparatus for cooling and dehumidify purposes; and

e) peripheral detection sensor subunits, for collecting and reporting environmental data including atmospheric particulates, sulphur oxides, nitrogen oxides, and non-methane hydrocarbons so as to support air quality assessment, and for collecting wireless geomagnetic detection data so as to detect the current status of each parking space.

According to another aspect, a method of electronic payment using the aforesaid electronic payment system is provided, comprising any combinations of the following:

a) the user registers his/her personal data on the electronic payment card driven payment platform by means of its mobile application, comprising one or more contactless type electronic payment cards, renewing electronic payment card, renewing financial apparatus, renewing phone number and email account, a dedicated account number of the electronic payment card driven payment platform will be assigned to this user;

b) the registered user pays for service charge with his/her registered electronic payment card via the contactless type electronic payment card;

c) the registered user can link the electronic payment card to another electronic payment card for registration, wherein the linking comprises inputting the number of a credit card on the mobile application and paying from the credit card;

d) the server of the electronic payment card driven payment platform receives the electronic payment card of the registered user, if any pending registered user does not confirm renewing fee, the next user who need to renew will override the functions of the PPP, and the PPP will determine if the electronic payment card is registered or not;

e) the apparatus will communicate with the electronic payment card driven payment platform at the central data center via a telecommunication means (e.g. fixed-network, telephone line, short message, 2G, 3G, 4G, etc.);

f) if it is confirmed that the registered user is already connected to the registered payment card on the electronic payment card driven payment platform, the electronic payment card driven payment platform will send out a payment message (via voice call (IVRS), short message service (SMS), and/or smart phone notification message) to the mobile phone of the registered user;

g) the registered user confirms the service message sent by the electronic payment card driven payment platform by voice communication, short message or mobile application, so as to confirm the corresponding service of the smart service terminal means;

h) if the registered user confirms to use the service of the electronic payment card driven payment platform: the registered user can select between: Option 1) accept the automatically assigned timeslot or the automatically extended service time before the current service time expires; or Option 2) the registered user can consider to confirm accepting to renew the service time of the designated smart service terminal apparatus by telephone service, and to accept receiving an alert message of a pre-defined grace period; or Option 3) the registered user voluntarily logs in the electronic payment card driven payment platform;

i) if the registered user selects the Option (1), the service selected by the registered user will be renewed remotely; after the registered user confirms to renew the service, an exact payment amount will be paid through the electronic payment card driven payment platform;

j) if the registered user uses a credit card/a prepaid card to renew the service, the transaction of renewing service will be updated directly on the electronic payment card driven payment platform;

k) if the registered card is a debit card, the user have to use the mobile phone connected to an apparatus which support debit card payment to perform payment in real time;

l) if the registered user selects the Option (2), an alert message will be sent to the registered user before a pre-defined grace period or the service expires;

m) if the registered user selects the Option (3), he/she can choose to confirm and renew the service request directly;

n) perform the payment processes of steps j to k;

o) the registered user confirms the required service selected to perform service renewal remotely;

p) the electronic payment card driven payment platform will update the required service renewal of the central payment operation control platform, and update the designated EPM via mobile communication network; and

q) finally, the user's mobile phone will receive a notification message via voice call (IVRS), short message service (SMS) and/or smartphone application to make the final confirmation on the transaction.

### BRIEF DESCRIPTION OF THE DRAWINGS

The accompanying drawings illustrate one or more embodiments and, together with the written description, serve to explain the principles. Wherever possible, the same reference numbers are used throughout the drawings to refer to the same or like elements of an embodiment, and wherein:

FIG. 1 is a system configuration diagram of a preferred embodiment of the radio frequency identification card and smart phone interlinking embedded renewing payment apparatus and methods;

FIG. 2 is an apparatus configuration diagram of a preferred embodiment of the radio frequency identification card and smart phone interlinking embedded renewing payment apparatus and methods;

FIG. 3 is a flow chart showing the implementation of data encryption and decryption of the radio frequency identification card and smart phone interlinking embedded renewing payment apparatus and methods in some embodiments;

FIG. 4 is the embedded central processor configuration of the radio frequency identification card and smart phone interlinking embedded renewing payment apparatus and methods in some embodiments;

FIG. 5 is a flowchart for implementation of the embedded central processor of the radio frequency identification card and smart phone interlinking embedded renewing payment apparatus and methods in some embodiments;

FIG. 6 is a flowchart of transaction data of the radio frequency identification card and smart phone interlinking embedded renewing payment apparatus and methods in some embodiments;

FIG. 7 is a flowchart of preferred embodiment of the radio frequency identification card and smart phone interlinking embedded renewing payment apparatus and methods in some embodiments;

FIG. 8 is the hardware security encryption and decryption unit configuration of the radio frequency identification card and smart phone interlinking embedded renewing payment apparatus and methods in some embodiments;

FIG. 9 is a schematic diagram of a one-stop for a consumer to perform, confirm, and pay at the designated apparatus and a schematic diagram showing received electronic receipt in some embodiments;

FIG. 10 is a schematic diagram showing the present apparatus automatically performing a service renewal request for a second time in some embodiments;

FIG. 11 shows in some embodiments that a management staff performs maintenance operation by a handheld data collection means apparatus for uploading or downloading information from a collection apparatus and issuing a penalty ticket to a consumer who used the service exceeding the time limit of the present apparatus.

### DETAILED DESCRIPTION

The application provides in some embodiments apparatus and methods for renewing payment based on interlinking of radio frequency identification cards, mobile phones with electronic payment apparatuses implemented as embedded devices. In the age of the Internet of Things, that is, to make all the items connected to the Internet, and then use the Internet to achieve real-time query, remote control, remote monitoring, and to carry out a number of value-added applications through the intelligent management thereof, so as to achieve the intelligent life mode characterized by the three features “all-round perception, reliable transmission, and intelligent processing”. The electronic payment apparatus can support two-way communication, and can support service fee payment and remote renewal payments, as well as real-time collection of the security and environmental information relating to electronic payment apparatus. The electronic payment system can form part of the information and communication technology infrastructure of a smart city. The collection of the foregoing security and environmental information would facilitate the implementation of a smart city that addresses issues in one or more aspects of the city including governance, economy, mobility, environment, living and people, thereby improving the quality of life of the citizens and enhancing the sustainable growth and competitiveness of the city.

The apparatus and methods will now be described in further detail with reference to the accompanying drawings and embodiments.

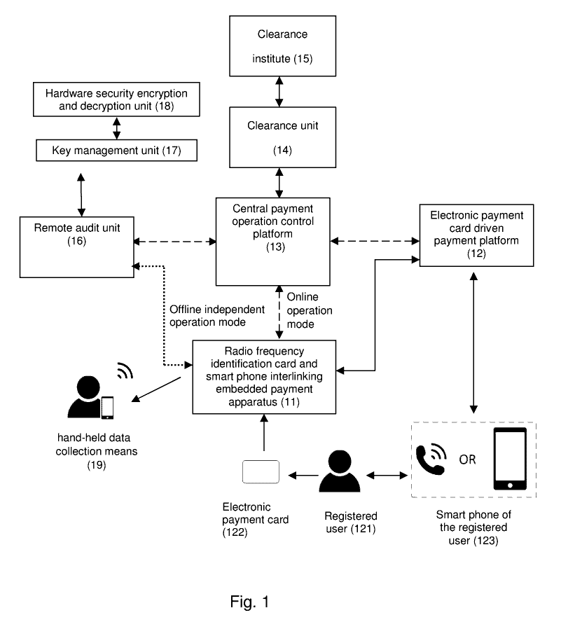

FIG. 1 shows a system configuration diagram of a preferred embodiment relating to a radio frequency identification card and smart phone interlinking embedded payment apparatus and methods thereof. The radio frequency identification card and smart phone interlinking embedded payment apparatus 11 interlinks an electronic payment card driven payment platform 12 and a central payment operation control platform 13, to complete a payment renewal on a designated service terminal remotely and in real-time by means of a single apparatus, a one-stop or two-step method, to provide a radio frequency identification card payment system service using the debit card, the credit card or the prepaid card which are convenient to the public, and process all payment transactions through the clearance unit 14 to receive payments and provide a clearance institute 15 for clearance processing, the remote audit unit 16 audits the authenticity of the record to ensure that payment transactions with the consumer are completed, the key management unit 17 and the hardware security encryption and decryption unit 18 ensure that all data is securely delivered, in remote areas or the areas not covered by the telecommunication networks, said apparatus sets up an appropriate communication port to connect hand-held data collection means 19, so as to create a new basis for automated payment and facility management requirements for future public short-term rental services. This system provides a one-stop mode of performing, confirming and paying for a designated payment system apparatus through an embedded information technical computer and radio frequency identification technology, and then automatically performing extension of the service time in a second time to a designated service terminal apparatus, without returning to the specified service terminal apparatus and no need to re-enter the designated payment system apparatus identifier thereof, thereby avoiding mistake in entering the apparatus identifier and hence causing a subsequent renewing error.

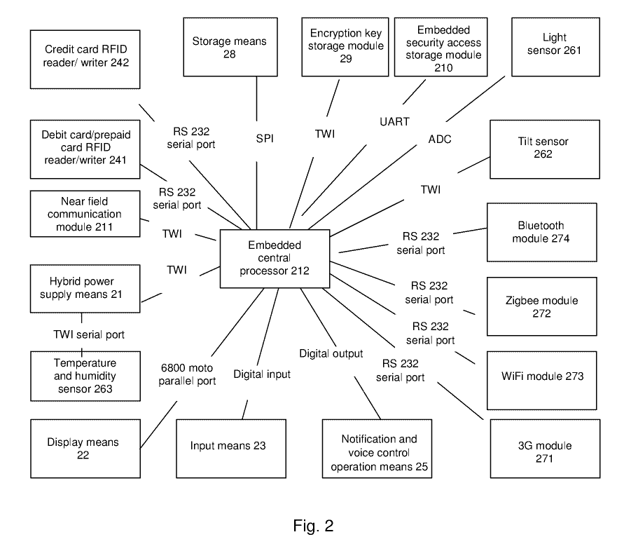

FIG. 2 shows a radio frequency identification card and smart phone interlinking embedded electronic payment apparatus, which is characterized in that it comprises a aluminum alloy housing, a hybrid power supply means 21, a display means 22, an input means 23, a radio frequency identification reader and-writer and its antenna set 24, a notification and voice control operation means 25, a sensing means, a wireless communication unit and its antenna set 27, a storage means 28, an encryption key storage module 29, an embedded security access storage module 210, a near field communication module 211, and an embedded central processor 212.

According to an embodiment, the hybrid power supply means 21 is characterized in that it supports a plurality sets of disposable alkaline batteries, a rechargeable battery power supply circuit and a backup rechargeable lithium battery; a display means characterized in that it comprises a display apparatus and a timing controller, wherein the input means 23 comprises a plurality sets of buttons which are momentary buttons and can be switched on and off by a piezoelectric material, which is made of stainless steel and is sealed and waterproof, and has easy-to-clean metal surface.

The radio frequency identification reading and writing unit comprises a debit card/a prepaid card RFID reader and writer 241, and a credit card RFID reader and writer 242, connected to the antenna set for reading and writing operation of the radio frequency identification tag; the adjustment circuit inside the antenna set is used for adjusting the sensitivity of the radio frequency antenna element, if the debit card reader and writer is selected for operation, then the credit card reader and writer remains idle and the reader and writer antenna remains off to avoid affecting the performance of the debit card reader and writer; on the contrary, if the credit card reader and writer is selected to operate, the debit card reader and writer remains idle and the reader and writer antenna remains off.

According to an embodiment, the notification and voice control operation means 25 comprises a plurality groups of buzzers, an accounting notification light, a remaining time notification light and a power supply notification light, and is mainly used for indicating a payment status, wherein:

The buzzer makes sound when the application is operating. When the card is placed near the reader, for example, the radio frequency identification tag reader and writer completes the transaction, the buzzer can make a sound. When the top cover is opened in case of theft, the buzzer will make a high-frequency sound in real time;

The accounting notification light is installed in front of the apparatus, for indicating the payment status of the charging means. The green notification light is used to indicate the status of the user's payment charging apparatus, when the green power notification light is on, indicates the payment has gone through the payment charging apparatus and turned on, when the green charging notification light is off, the red light representing the overtime notification light, which means that the service has expired or the payment has not gone through.

The red overtime notification light can also be installed at the rear end of the apparatus to show the operation staff, if the user is still using the service apparatus exceeding time limit, the staff can request a penalty fine to the overtime user;

If the power supply notification light indicates a low power state, the staff needs to replace the disposable alkaline battery pack or to recharge the lithium battery.

The sensing means is characterized by in some embodiments a light sensor 261, a tilt sensor 262 and a temperature sensor which form input interfaces for theft alarm, accidental collision and cooling.

The wireless communication unit and its antenna set 27 comprises a 3G module 271, a Zigbee module 272, a WiFi module 273, and a Bluetooth module 274.

Wherein the storage means 28 in some embodiments comprises five non-volatile read/write memories to store all relevant data. If the memory is full, no further transaction records can be stored, and the smart service terminal apparatus does not in some embodiments allow access to purchase service time and display the words like unavailable, etc.

The five non-volatile read/write memories in some embodiments comprise “Main Record Storage”, “Bad Debt Card Blacklist Storage”, “Radio Frequency Identification Reader and Writer File Storage”, “Real-time Comprehensive Backup Storage”, and “Whole Set Upload Record Backup Storage”. The main record storage stores all transaction records; the bad debt card blacklist storage stores bad debt card blacklist; the RFID tag reader and writer file storage stores all the RFID tag reader and writer update documents, settings and firmware upgrades; the real-time comprehensive backup storage stores all transaction records in real time; the whole set upload record backup storage stores all data of the storage means for backup purposes.

According to an embodiment, the encryption key storage module 29 and the embedded security access storage module 210 are used for key storage and are capable of providing the function of periodically replacing encryption keys for decryption.

The encryption key storage module 29 (CryptoMemory) integrates a hardware encryption engine and an encryption level hardware random number generator, and can securely manage up to four keys downloaded from the central payment operation control platform to implement the encryption algorithm and securely store it in EEPROM, said crypto memory is provided with an embedded hardware encryption engine, and the keys shall be securely stored in the settings and not allowed to be read or copied, so that the settings can mutually authenticate with the central payment operation control platform.

The embedded security access storage module 210 performs an encryption operation using an embedded SAM (secure access module) and has hardware security measures that allow secure storage of the keys. The embedded SAM can resist the impact of weather changes.

The near field communication module 211 provides a schematic diagram of the electronic receipt to the consumer to the designated apparatus, and the operation staff issuing a penalty notice schematic diagram to the overtime user according to the overtime status of the present apparatus.

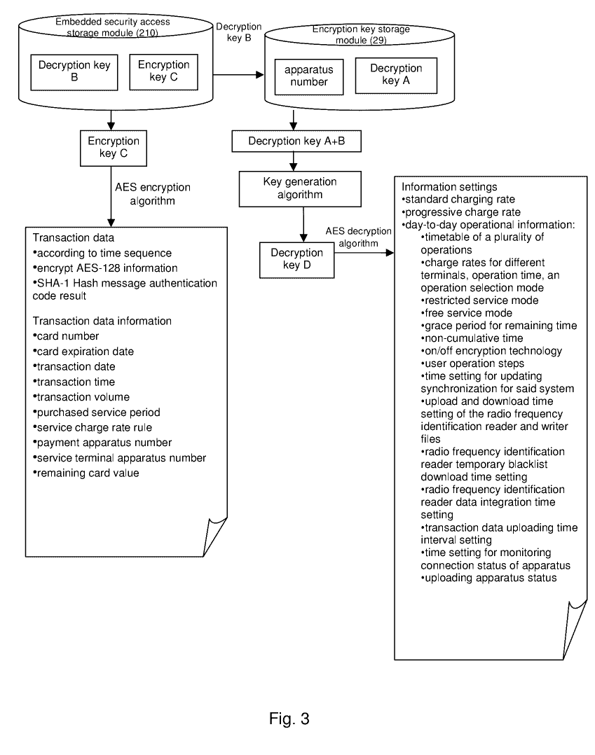

FIG. 3 is a flow chart showing the implementation of data encryption and decryption of the radio frequency identification card and smart phone interlinking embedded payment renewing apparatus.

According to an embodiment, the encryption key storage module 29 and the embedded security access storage module 210 are used for key storage and are capable of providing the function of periodically replacing encryption keys for decryption.

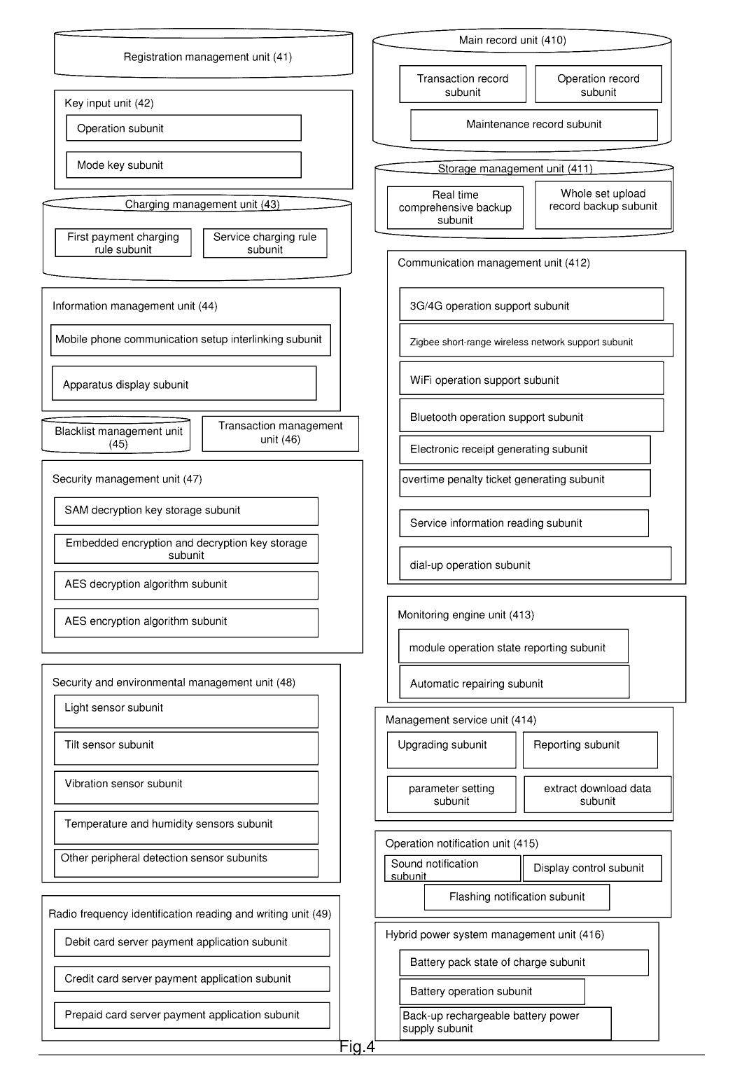

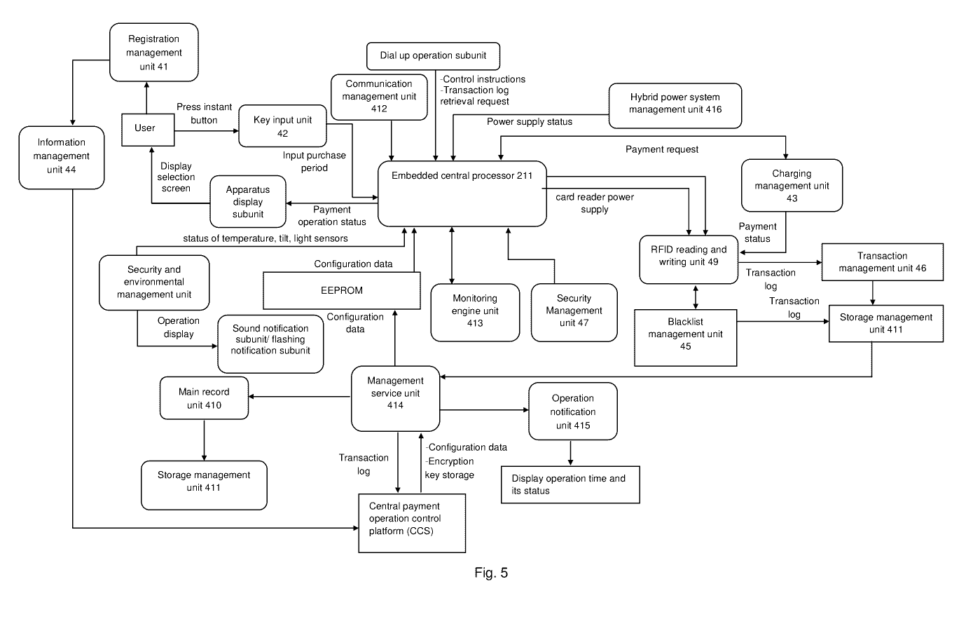

FIG. 4 shows a figure of the firmware structure of the central processor according to an embodiment. FIG. 5 is a flow chart for implementation of the embedded central processor of the radio frequency identification card and smart phone interlinking embedded payment renewing apparatus and methods.

According to an embodiment, the embedded central processor 212 controls, operates and manages all the embedded installed firmware modules, comprising an registration management unit 41, a key input unit 42, a charging management unit 33, an information management unit 44, a blacklist management unit 45, a transaction management unit 46, a security management unit 47, a security and environment management unit 48, a radio frequency identification reading and writing unit 49, a main record unit 410, a storage management unit 411, a communication management unit 412, a monitoring engine unit 413, management service unit 414, an operation notification unit 415, and hybrid power system management unit 416.

The electronic payment apparatus comprises a security and environmental management unit for protecting all data stored in the electronic payment apparatus, for automatically triggering a theft alarm in response to security incidents, and for notifying the central payment operation control platform the security incidents, wherein the security and environmental management unit comprises any combinations of the following:

a) a light sensor subunit, for destroying security data stored in the electronic payment apparatus and triggering an alarm in response to unauthorized opening of an external cover of the electronic payment apparatus;

b) a tilt sensor subunit, for anti-theft and mechanical impact detection of the electronic payment apparatus, wherein the tilt sensor will trigger an alarm when the electronic payment apparatus tilts beyond a preset angular degree;

c) a vibration sensor subunit, for abnormal vibration detection, the vibration sensor will trigger an alarm when the electronic payment apparatus is hit and disrupted;

d) a temperature and humidity sensor subunit, for measuring the temperature and humidity, wherein the temperature and humidity sensor subunit is configured to report measurements regularly and send alerts automatically when temperature or humidity exceeds preset values, and wherein the temperature and humidity sensor subunit also triggers to operate a cooling fan in the electronic payment apparatus for cooling and dehumidify purposes; and

e) peripheral detection sensor subunits, for collecting and reporting environmental data including atmospheric particulates, sulphur oxides, nitrogen oxides, and non-methane hydrocarbons so as to support air quality assessment, and for collecting wireless geomagnetic detection data so as to detect the current status of each parking space.

Advantageously, the electronic payment apparatus comprises any combinations of the following:

a housing;

a hybrid power supply means;

a display means;

an input means, for receiving input from the consumer;

a radio frequency identification reader and writer and its antenna set;

a notification and voice control operation means;

a sensing means;

a wireless communication means and its antenna set;

a storage means;

an encryption key storage module;

an embedded security access memory module;

a near field communication module; and

an embedded central processor, wherein the embedded central processor is configured to control, operate and manage units including any combinations of the following:

an registration management unit 41;

a key input unit 42, for receiving a service request from the user;

a charging management unit 43;

an information management unit 44;

a blacklist management unit 45;

a transaction management unit 46;

a security management unit 47;

a security and environment management unit 48;

a RFID reading and writing unit 49;

a main record unit 410;

a storage management unit 411;

a communication management unit 412;

a monitoring engine unit 413;

a management service unit 414;

an operation notification unit 415; and

a hybrid power system management unit 416.

According to an embodiment, the registration management unit 42 manages and stores information relating to transactions, including:

accounts of electronic payment cards used for the first payment;

information about the electronic payment cards used for renewing payment;

information about the electronic payment apparatus used for renewing payment;

mobile phone numbers used for renewing payment; and

email accounts of the consumers registered to the electronic payment card driven payment platform.

According to an embodiment, when a timer controller receives a key in signal of the user for payment request, the electronic payment apparatus will turn from sleep mode to power operation mode; wherein after a specified operation time or when the electronic payment apparatus does not receive the user's payment, the electronic payment apparatus will automatically turn off the power supply of a relevant power consumption unit and turn to sleep mode, to save power consumption; and wherein the key input unit 42 further comprising any combinations of the following:

a) an operation subunit, comprising a plurality of momentary buttons to select a desired service terminal; to select a service request; to select between a debit card, a credit card, and a prepaid card for the radio frequency identification card reader and writer to make payment; and to receive an electronic receipt in real-time;

b) a mode key subunit, for a maintenance personnel to create the mode key of the electronic payment apparatus formed by a sequence of button inputs; and for a maintenance personnel to turn on a WiFi module or a Bluetooth module in the wireless communication unit and its antenna set for maintenance operation.

According to an embodiment, the charging management unit 43 further comprises:

a first payment charging rule subunit, for calculating a required fee based on the service request entered by a consumer via the operation subunit and rules set by a service terminal provider; and

a service charging rule subunit, for calculating a required fee based on remote charging rules set by the service terminal provider.

According to an embodiment, the information management unit 44 further comprises:

an apparatus display subunit, for instantly displaying a service selected by a consumer and fees associated with the service, and for displaying charged payment data on the display means after confirmation of the payment; and

a mobile phone communication setup interlinking subunit, for confirming that the consumer's electronic payment card is registered on the electronic payment card driven payment platform, for connecting the consumer's smartphone for communication, and for sending to the consumer payment information, wherein the payment information includes: the first payment electronic receipt obtained by means of the consumer's short message service (SMS), renewal request, and extended renewal request.

According to an embodiment, the blacklist management unit 45 manages and stores information including: bad debts; stolen, cloned or expired electronic payment card; mobile phone number and e-mail account of card holder, in a separate memory module.

According to an embodiment, after the blacklist management unit 45 checks against a blacklist, the transaction management unit 46 confirms processing the payment, and generates transaction data information including: transaction number, electronic payment card number, expiry date of electronic payment card, transaction date, transaction time, purchased service request, service charge, electronic payment apparatus identifier, service terminal identifier, and remaining value of electronic payment card.

Advantageously, the RFID reader and writer module stores and uploads the transaction data to the central payment operation control platform, the transaction data including: card type, card ID, card expiry date, transaction date and time, transaction amount, purchased service, the apparatus identifier, service terminal number, card balance value, and further comprises any combinations of the following:

a) a debit card server payment application subunit, used to perform a whole debit payment transaction of a deposited amount, the cardholder shall pay based on the balance in the card when using the card, that is, overdraft is not allowed

b) a credit card server payment application subunit, used to perform a whole credit payment transaction within a credit limit, a card holder may spend by using the credit card within the credit limit and then repay later;

c) a prepaid card server payment application subunit, used to perform the payment transaction of the deposit amount and overdraft, the cardholder may deposit a certain amount of money according to the requirements of the card issuing institution, and when the deposit amount is insufficient for the payment, the card can be overdrawn within a defined credit amount.

According to an embodiment, the main record unit further comprises any combinations of the following:

a) a transaction record subunit, for managing and storing memory blocks separated from an internal memory, the internal memory stores transaction records and hashed results of the transaction records, wherein the transaction records comprise: card type, card number, card expiration date, transaction date, transaction time, transaction amount, purchased service time, service charge rate rule, the electronic payment apparatus identifier, remaining card value, and finally the transaction records are verified by hash verification codes, the transaction records shall be periodically uploaded to the central payment operational control platform for data analysis;

b) an operation record subunit, for managing and storing operation data information in the memory blocks separated from the internal memory, the operation data information comprises: the electronic payment apparatus downtime, date and time when the terminal service is not provided, date and time when the terminal service is free, recorded prescheduled or abnormal restart time, failed transaction records resulted from the cards in the blacklist, cumulative daily operating hours, and battery low notification;

c) a maintenance record subunit, for managing and storing maintenance information in the memory blocks separated from the internal memory, and for maintaining the maintenance information which comprises diagnosis and repair logs, and date of battery replacement.

According to an embodiment, the security management unit 47 manages a plurality of encryption and decryption keys generated by the key management unit by using a main key; wherein the security management unit further comprises any combinations of the following:

a) a SAM decryption key storage subunit, for storing the electronic payment apparatus identifier, a first decryption key (A), and a key generation algorithm; wherein said key generation algorithm generates a fourth decryption key (D) using said first decryption key (A) and a second decryption key (B) that is embedded in said encryption key storage subunit;

b) an embedded encryption and decryption keys storage subunit, for storing the second decryption key (B) and a third encryption key “C” that is stored in an encrypted chip and cannot be disassembled nor cracked from said electronic payment apparatus;

c) an Advanced Encryption Standard (AES) decryption algorithm subunit, for decrypting data and system settings sent to the said electronic payment apparatus from said central payment operation control platform using the security check of the fourth decryption key (D) at AES; wherein the data and system settings include any combinations of the following:

(i) standard charge rate,

(ii) progressive charge rate, and

(iii) daily operational information, the daily operational information includes: a timetable of a plurality of operations, and the charge rates for different terminals, operation time, an operation selection mode, a restricted service mode, a free service mode, a grace period for remaining time, a non-cumulative time, on/off encryption technology and the user operation steps; wherein the system settings updates:

synchronizing time setting,

upload and download time setting of the radio frequency identification reader and writer files,

radio frequency identification reader and writer temporary blacklist download time setting,

radio frequency identification reader and writer data integration time setting, and

transaction data uploading time interval setting,

d) an Advanced Encryption Standard (AES) encryption algorithm subunit, for encrypting and uploading the information data files using the third encryption key (C) by the AES security check for the data sent from the electronic payment apparatus to the central payment operation control platform, the information data files comprise any combinations of the following:

the transaction data information,

the security and environmental information, and

the operational data information and the maintenance data.

According to an embodiment, the storage management unit 411 stores the records of the electronic payment apparatus in a time-sequential manner in a linear buffer mode in the storage block separated from the internal memory, wherein each transaction data is generated and recorded based on the transaction details, and its SHA-1 (cryptographic hash function) is generated and used, which preserves the integrity and authenticity of each transaction data, and also enhances the reliability of the data transmission process from the electronic payment apparatus to the central payment operation control platform and ensures the correctness of transaction data for subsequent clearance and settlement, wherein the electronic payment apparatus further comprising any combinations of the following:

a) a real-time comprehensive backup subunit, which stores all data of the storage means for backup purposes, including the overall transaction table, each transaction record, bad debt card blacklist, operational data, maintenance information; whenever there is data loss in the main record area, the information can still be recovered from the real-time comprehensive backup area;

b) a whole set upload record backup subunit, for storing the whole data set of the real-time comprehensive backup area as a backup copy, this data set is stored in this area until the data set has been successfully uploaded to the central payment operation control platform, and preparing for uploading the next data set; in case that a data set collected by the control platform is lost or the data set can't be uploaded to the control platform due to network and other problems, the original data set still has to be uploaded to the control platform control from the backup area until a special password is used to control and activate; the data backup copy being transmitted to the control platform confirms that the data set that has been recorded in the control platform database is not repeatedly recorded.

According to an embodiment, the communication management unit 412 further comprises any combinations of the following:

a) a 3G/4G operation support subunit, to remotely communicate with a plurality of the electronic payment apparatus in an area covered by the telecommunication network, and to upload and download the information data files;

b) a Zigbee short-range wireless network support subunit, to provide a master/slave mode in a range of several-tens meters to form a point-to-point communication network of master/slave apparatus; the master apparatus may actively read the data transmitted from the slave apparatus, the slave apparatus is simply used as a wireless link in the network to other slave apparatus, and can form real network for access and management; once an abnormal problem is presented in the wireless network, the electronic payment apparatus can automatically switch from the master mode to the slave mode, initiate the master apparatus in the closest distance, transmit the data to the master apparatus and send it back to the control platform;

c) a WiFi operation support subunit, for emergency backup in remote areas or areas that are not covered by telecommunications network, to enable an appropriate communication port to connect to a handheld data collection means apparatus, allowing operator to utilize mobile applications (supporting android/iOS) within the handheld operating means for short-distance maintenance operations or to collect information uploaded and downloaded by the electronic payment apparatus;

d) a Bluetooth operation support subunit, having same functions as those of the WiFi operation support subunit and the Zigbee operation support subunit, used as a backup wireless network transmission;

e) an electronic receipt generating subunit, for the consumer to receive an electronic receipt via a financial card driven payment platform using a mobile phone equipped with short-range wireless communication.

f) a service information reading subunit, for the consumer to receive the electronic service information via the electronic payment card driven payment platform using the mobile phone equipped with short-range wireless communication.

g) an overtime penalty ticket generating subunit, for an operator to use the hand-held operating means to issue a penalty ticket at a short range to consumer who used the service exceeding the time limit.

h) a dial-up operation subunit, to provide a temporary service function, and the control platform can dial a particular telephone number of the electronic payment apparatus; the electronic payment apparatus then connects the call and verifies the telephone number transferred to the control platform, after that verifies the call is coming from the control platform; then the electronic payment apparatus will perform a specific operation such as remote recharging, document downloading, etc., by connecting to the control platform via HTTPS and sending status flags; the dial-up operation subunit also allows the consumer to make a call to the electronic payment apparatus using the financial card driven payment platform, to add renew fees.

According to an embodiment, the monitoring engine unit 413 is connected with each component of the electronic payment apparatus and monitors the operation states of all the components, and the electronic payment apparatus further comprises any combinations of the following:

a) a module operation state reporting unit, which extracts the current operation state of each component in the electronic payment apparatus, establishes a fault log and sends information of the fault states to the designated recording location; and

b) an automatic repair unit, which, in accordance with the predicted improper operation, repairs the fault module without interfering with the system applications or business applications.

According to an embodiment, the management service unit 414 further comprises any combinations of the following:

a) an upgrading subunit, used to upgrade the electronic payment apparatus firmware or software via a local port or a remote network;

b) a reporting subunit, used to send the current operation state of each module to the operator of the electronic payment apparatus;

c) a parameter setting subunit, for the operator to enter the relevant parameters of each module within the electronic payment apparatus, to set the system settings; and

d) an extract download data subunit, for the operator to download and store the update documents, settings and firmware upgrades of all RFID readers and writers from the central payment operation control platform periodically.

According to an embodiment, the operation notification unit 415 issues a notification signal to the consumer according to the operation state, wherein the electronic payment apparatus further comprises any combinations of the following:

a) a sound notification subunit, to notify the operation state to the consumer by sound signal, for example, it will make a sound when a button is pressed or a card is swiped, indicating a successful transaction;

b) a flashing notification subunit, to indicate the operation state to the consumer by light signal; and

c) a display control subunit, showing the rental time, timer or electricity meter of battery status, information relating to the operating procedures, and is capable of displaying other relevant information including weather information sent by the central payment operation control platform to the display means.

According to an embodiment, the hybrid power system management unit 416 provides power to the whole electronic payment apparatus, and supports a plural sets of disposable alkaline battery packs, rechargeable battery packs, backup rechargeable battery and a hybrid power supply circuit thereof, wherein the electronic payment apparatus further comprises any combinations of the following:

a) a battery pack state of charge subunit, which is used to accurately estimate the charging state of the battery packs, i.e. the remaining battery power, to ensure that the charging state is maintained within a reasonable range, to prevent damage to the battery due to over discharge, and hence to predict in real time how much energy is remaining in the energy storage battery, or to predict the charging state of energy storage battery.

b) a battery operation subunit, which is used to calculate the charging state of a multiple battery packs in sequence or comparatively, to automatically make equalization control and achieve a low power consumption; whenever the battery pack is under voltage, the power is about to run out or the power is cut off abruptly, another set of battery packs will feed the power to the direct circuit, without switching time; the battery packs can feed power in accordance with a predetermined sequence, and hence the maintenance staff would not easily change the wrong batteries.

c) a back-up rechargeable battery power supply subunit, which is used to provide a back-up electricity power; when the primary alkaline battery or the rechargeable battery needs to be replaced, the display means and the notification operation apparatus can still run for a short period of time to let the maintenance staff know that the whole apparatus is still running, to avoid loss of any storage data.

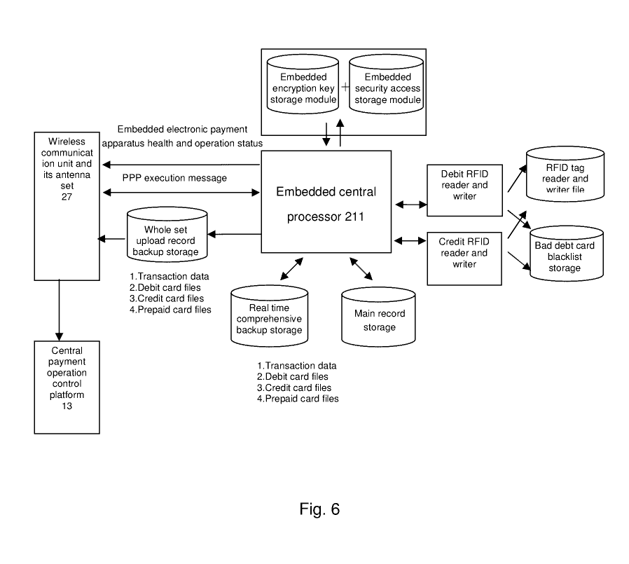

FIG. 6 is a flow chart of transaction data of the radio frequency identification card and smart phone interlinking embedded payment renewing apparatus and methods.

According to an embodiment, the electronic payment card driven payment by phone platform (PPP) provides a payment platform application program, which offers further convenience for a registered user, supporting both Android and iOS systems and supporting a variety of different payment clearance institutions, without having to physically return to the electronic payment apparatus to renew service time of a paid service, when a registered user finishes at a first time using his/her registered electronic payment card on the apparatus to execute, confirm and pay the purchased service, the payment record of the electronic payment card is uploaded to the control platform, and the user's electronic payment card number can be found by the control platform from the payment record and the paired apparatus will be found automatically to renew the service time, without the user having to enter the apparatus identifier into the electronic payment card driven payment platform so as to avoid mistake in entering the apparatus identifier, the registered users may choose to pay a second renewal service fee by using an interactive voice response system (IVRS) from an ordinary phone, a short message service, or by a mobile application on a smartphone, so that the purchased service request is accurately reflected in the apparatus, the electronic payment card driven payment platform is configured that the registered user may pay from one or more of the apparatus and avoid abusing the service terminal;

wherein when the service time expires, pairing is needed between the registered user and the registered electronic payment card, the user can receive expiry information via a voice call (via IVRS processing), a short message service (SMS) or a mobile application on a smartphone, then the registered user can pay for more service time by using the above means without having to return to the apparatus, the purchased service can be accurately reflected in the apparatus when the electronic payment procurement process is successfully completed, then the payment clearance process will be performed on the apparatus specified by the electronic payment card driven payment platform.

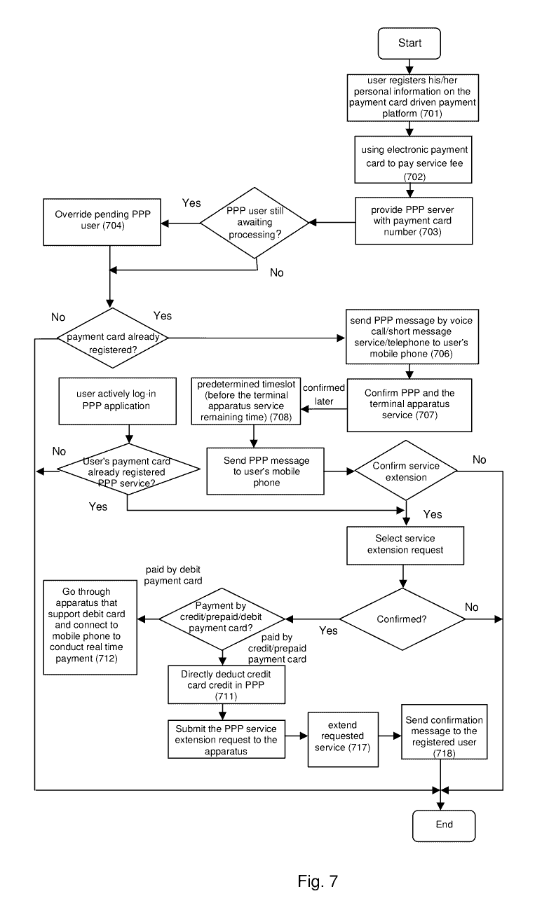

FIG. 7 is a flow chart of a preferred embodiment of the radio frequency identification card and smart phone interlinking embedded payment renewing apparatus and methods.

This section will briefly describe the operation process of an embodiment as illustrated in FIG. 1.

Step 701: The user registers his/her personal data on the electronic payment card driven payment platform by means of his/her mobile application, comprising one or more electronic payment cards, renewing electronic payment card, payment apparatus used for renewing, mobile phone number used for renewing and email account used for renewing, a dedicated account number of the electronic payment card driven payment platform will be assigned to this user;

Step 702: The registered user pays for service charge with his/her registered electronic payment card via the contactless type electronic payment card;

Step 703: The registered user can link the electronic payment card to another electronic payment card for registration, for example, the consumer can input a credit card number on the mobile application and pays from the credit card;

Step 704: The server of the electronic payment card driven payment platform receives the electronic payment card of the registered user, if any pending registered user does not confirm renewing fee, the next user who need to renew will override the functions of the PPP, and the PPP will determine if the electronic payment card is registered or not;

Step 705: The apparatus will communicate with the electronic payment card driven payment platform at the central data center via a telecommunication means (e.g. fixed-network, telephone line, short message, 2G, 3G, 4G, etc.);

Step 706: If it is confirmed that the registered user is already connected to the registered payment card on the electronic payment card driven payment platform, the electronic payment card driven payment platform will send out a payment message (via voice call (IVRS), short message service (SMS), and/or smart phone notification message) to the mobile phone of the registered user;

Step 707: The registered user must, in some cases, confirm to the service message sent by the electronic payment card driven payment platform by voice communication, short message or mobile application, so as to confirm the corresponding service of the smart service terminal means;

Step 708: If the registered user confirm to use the service of the electronic payment card driven payment platform: the registered user can select 1) accept the automatically assigned timeslot or the automatically extended service time before the current service time expires; or 2) the registered user can consider to confirm accepting to renew the service time of the designated smart service terminal apparatus by telephone service, and to accept receiving an alert message of a pre-defined grace period; or 3) the registered user voluntarily logs in the electronic payment card driven payment platform;

Step 709: If the registered user selects Option (1), the service selected by the registered user will be renewed remotely;

Step 710: After the registered user confirms to renew the service, an exact payment amount will be paid through the electronic payment card driven payment platform;

Step 711: If the registered user uses a credit card/a prepaid card to renew the service, the transaction of renewing service will be updated directly on the electronic payment card driven payment platform;

Step 712: If the registered card is a debit card, the user have to use the mobile phone connected to an apparatus supporting debit card payment to perform payment in real time;

Step 713: If the registered user selects Option (2), an alert message will be sent to the registered user before a pre-defined grace period or the service expires;

Step 714: If the registered user selects Option (3), he/she can choose to confirm and renew the service request directly;

Step 715: Perform the payment processes of Steps 711-712;

Step 716: The registered user confirms the required service selected to perform service renewal remotely;

Step 717: The electronic payment card driven payment platform will update the required service renewal of the central payment operation control platform, and update the designated EPM via mobile communication network;

Step 718: Finally, the user's mobile phone will receive a notification message via voice call (IVRS), short message service (SMS) and/or smartphone to make the final confirmation on the transaction.

The central payment operation control platform 13 is used for real-time monitoring and managing module, the system setting module, the payment apparatus setting module, the operator account setting module, the log management module and the report module to organize the transaction settlement, and to collect data and income reports, to detect the invalid special transaction reports, to coordinate the financial reports and the statistical reports;

The central payment operation control platform 13 comprises a central processing unit, a central database unit, an apparatus data communication unit, a settlement communication unit, a data backup system, a network printer and an uninterruptible power supply for daily operation and system management.

The central processing unit is used for real-time monitoring and management module, the system setting module, the radio frequency identification card and the smart phone interlinking embedded payment renewal apparatus setting module, the operator account setting module, the log management module and the reporting module to organize the transaction settlement, to collect data and income reports, to detect invalid special transaction reports, to coordinate financial reports and statistical report.

The real-time monitoring and management module is used to monitor the setting operation status and alarm, it can directly control the operation mode of the smart parking meter and alarm remotely to reset, and also provides continuous detection function, and periodically connect and access said setting, to determine the existence of its apparatus.

The system setting module manages the IP address setting and area setting of each of the settings, and the area name can be displayed on a map and used for key management.

The radio frequency identification card and smart phone interlinking embedded payment renewing apparatus setting can be chosen to support one or more service terminal apparatus, service time zone for individual service terminals, unlimited number of time zone settings, standard service charging rate setting, and progressive service charging rate setting, service grace period setting, timeout setting, cumulative/non-cumulative time setting.

The operator account setting module is used for registration management, changing password, the resettable operator, user, group or individual files using/accessing level, such as file opening, downloading, updating, deleting, index setting, printing and adding annotations, and so on.

The log management module is used for database maintenance and the setting log retrieval, and backing up the expired or standby archive files to the backup database to reduce the system load so as to improve the overall performance.

The reporting module makes the setting operation status report, the security and operational event report, and the setting summary report.

The central database unit is used to store all transaction settlement data, all documents and user activities will be automatically recorded in the system's tracing inspections. Audit data can also be extracted for industry specifications and analysis reports.

The apparatus data communication unit is used for secure data communication and used to monitor the functional status of the apparatus. Update and deliver programmable data: such as standard service charge, progressive service charge, time, date, week and operation schedule (time zone setting), operation mode, grace period, noncumulative time, timeout setting, blacklist card data download, encryption key download/selection, display time information, display information, light diode display status, transaction record, data and backup storage, internal timer, upload standard time, using encryption method to generate encryption key, Consistency between Hash function message authentication code in the received message and the sent message (integrity). This can be important in some embodiments in data exchange, especially when transmission medium such as public networks do not provide security guarantee.

The settlement communication unit is used to ensure the security, accuracy and reliability of data transfer function between the clearance unit 14 and the central payment operation control platform. The clearance unit 14 shall be able to exchange encrypted data with the clearance institute 15 in a secure and accurate manner through either dedicated lease lines or Secure Shell (“SSH”) protocol built on Virtual Private Network (“VPN”). When transmitting or receiving the formatted revenue uploading file from the central processing unit from private network through public network, the communication unit of the clearance institute shall encrypt the file into a clearance institute agreeable Hash format before sending the file.

The data backup system is used for backing up all the transaction settlement data, the setting inventory control, the financial management and the income audit, supporting payment apparatus maintenance operation and the strategic management statistical analysis.

The network printers is used for hardcopy of data, and can limit the system's printing and access functions to prevent leakage of confidential files.

The uninterruptible power supply is used to provide backup AC power supply for the data center of the central payment operation control system uninterruptedly in the case of abnormal power supply.

The clearance unit 14 processes all payment transactions of service fees to maintain a safe, reliable and efficient charging service, and to check and provide payment record dispute resolution to resolve the purpose of providing all revenue records for dispute resolution purposes.

The remote audit unit 16 can be scheduled to download any selection data for auditing the integrity and authenticity of one or more sets of records, and to give a special authorization to a record or a set of records if the message authentication code results do not match, i.e., verify the received message and sent message is not exactly the same or intact. It is responsible for compiling all high-performance standard reports, and the remote audit unit 16 can operate independently even if it is disconnected from the central payment operation control platform.

The handheld data collection means 19 is used for emergency backup, an Android or iOS based mobile handheld apparatus can off-line data collection from EPM. In remote areas or the areas not covered by telecommunications networks, the handheld operation means can perform data transfer to communicate with EPM via any Bluetooth or WiFi apparatus.

By using the master key, the key management unit 17 can generate a plurality sets of the encryption and decryption key A, the decryption key B and the encryption key C and download to the setting key memory, and the central payment operation control platform encrypts the transmission key to generate a transmission key cipher by using the private key, and then transmits the transmission key cipher to the setting; and the setting obtains the key cipher by using the key A, the decryption key B and the hash decryption key. Each of said sets encrypts a decryption key unique to the key memory, and said apparatus also periodically updates the encryption key and the decryption key, and sends the encryption key and the decryption key to the setting.

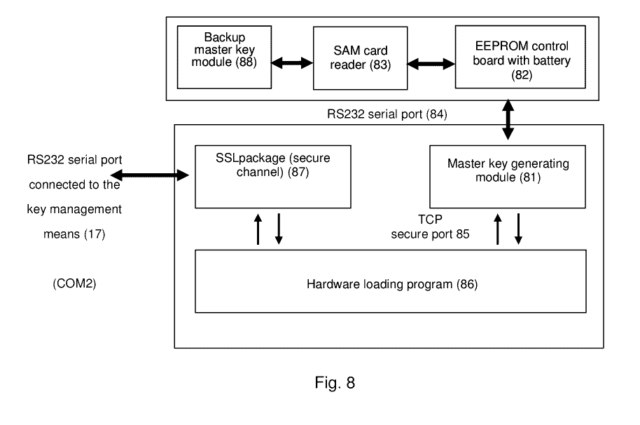

The hardware security encryption and decryption unit 18 is an apparatus that performs a cryptographic operation, and stores key data such as a private key and a master key in a hardware security encryption and decryption unit to replace a vulnerable attack apparatus. See FIG. 8, the master key generation module 81 of the hardware security encryption and decryption unit as shown uses the battery EEPROM control board 82 and the SAM card reader 83 to create five keys to five SAM cards through the RS232 serial port 84, and uses the key wrapping/unwrapping button and key package/by disassembling the master key, to load the master key to the hardware security encryption and decryption unit. And then sends the master key to the firmware loading program 86 through the TCP security port 85, finally, the hardware security encryption and decryption unit is connected to the key management unit 17 through the connection SSL package (secure channel) 87. The backup master key module 88 functions to backup the master key to five SAM cards for backup, and can recover the master key through the protocol setting. The hardware security encryption and decryption unit 8 has a self-destruction mechanism to protect the master key. When the HSM is destroyed, the master key is also destroyed. The master key shall be recovered by this module.

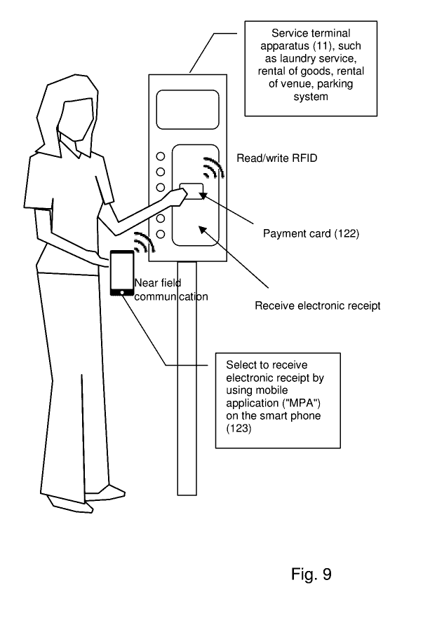

FIG. 9 is a diagram of a one-stop for a consumer to perform, confirm, and pay at the designated apparatus and a schematic diagram showing received electronic receipt.

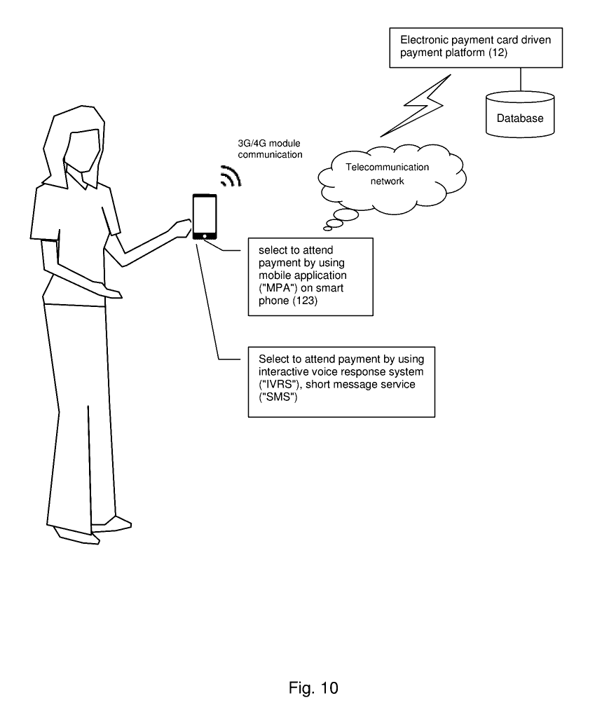

FIG. 10 is a diagram showing the present apparatus automatically performing a service renewal request for a second time.

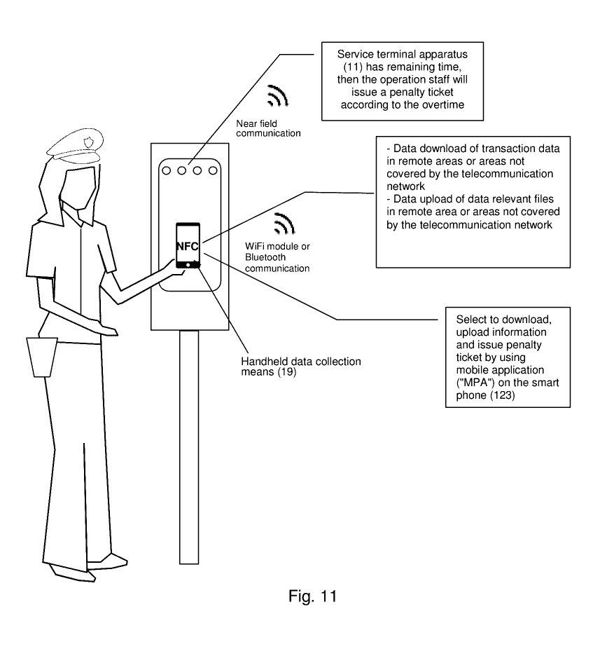

FIG. 11 shows that a management staff performs maintenance operation by a handheld data collection means for uploading or downloading information from a collection apparatus and issuing a penalty ticket to a consumer who used the service exceeding the time limit of the present apparatus

The foregoing description of the exemplary embodiments has been presented only for the purposes of illustration and description and is not intended to be exhaustive or to limit the invention to the precise forms disclosed. Many modifications and variations are possible in light of the above teaching. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited. The methods disclosed herein include certain actions taken by a practitioner; however, they can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately”, “about”, and “substantially” as used herein include the recited numbers (e.g., about 10%=10%), and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the invention is defined by the appended claims rather than the foregoing description and the exemplary embodiments described therein.

What is claimed is:

1. An electronic payment system based on interlinking of a radio frequency identification card and mobile phone with an electronic payment apparatus, comprising:
a plurality of electronic payment apparatuses operable in offline independent mode or network-connected mode, wherein said electronic payment apparatus simultaneously supports a plurality of sets of service terminals;
an electronic payment card driven payment platform;
a central payment operation control platform;
a clearance unit;
a remote audit unit;
a handheld data collection means;
a hardware security encryption and decryption unit;
a secured wireless communication unit;
a key management unit, through said secured wireless communication unit to input and output communication to perform radio frequency identification card driven payment service and to collect relevant data for central management;
wherein said electronic payment apparatus comprises a security and environmental management unit for protecting all data stored in said electronic payment apparatus, for automatically triggering a theft alarm in response to security incidents, for notifying the central payment operation control platform the security incidents, and for collecting and reporting environmental data, wherein said security and environmental management unit comprises:
a) a light sensor subunit configured to trigger an alarm in response to unauthorized opening of an external cover of the electronic payment apparatus;
b) a tilt sensor subunit, for anti-theft and mechanical impact detection of said electronic payment apparatus, wherein said tilt sensor will trigger an alarm when said electronic payment apparatus tilts beyond a preset angular degree;
c) a vibration sensor subunit configured to detect abnormal vibration, said vibration sensor will trigger an alarm when the electronic payment apparatus is hit and disrupted;
d) a temperature and humidity sensor subunit configured to measure the temperature and humidity, wherein the temperature and humidity sensor subunit is configured to report measurements regularly and send alerts automatically when temperature or humidity exceeds preset values, and wherein the temperature and humidity sensor subunit also triggers to operate a cooling fan in the electronic payment apparatus for cooling and dehumidify purposes; and
e) peripheral detection sensor subunits configured to collect and report environmental data including atmospheric particulates, sulphur oxides, nitrogen oxides, and non-methane hydrocarbons so as to support air quality assessment, and for collecting wireless geomagnetic detection data so as to detect the current status of each parking space.

2. The electronic payment system according to claim 1, wherein said electronic payment apparatus comprises:
a housing;
a hybrid power supply means;
a display means;
an input means, for receiving input from the consumer;
a radio frequency identification reader and writer and its antenna set;
a notification and voice control operation means;
a sensing means;
a wireless communication means and its antenna set;
a storage means;
an encryption key storage module;
an embedded security access memory module;
a near field communication module; and
an embedded central processor, wherein said embedded central processor is configured to control, operate and manage units including:
an registration management unit;
a key input unit, for receiving a service request from the user;
a charging management unit;
an information management unit;
a blacklist management unit;
a transaction management unit;
a security management unit;
a security and environment management unit;
a RFID reading and writing unit;
a main record unit;
a storage management unit;
a communication management unit;
an monitoring engine unit;
a management service unit;
an operation notification unit; and
a hybrid power system management unit.

3. The electronic payment system according to claim 2, wherein
said registration management unit manages and stores information relating to transactions, including:
accounts of electronic payment cards used for the first payment;
information about the electronic payment cards used for renewing payment;
information about the electronic payment apparatus used for renewing payment;
mobile phone numbers used for renewing payment; and
email accounts of the consumers registered to said electronic payment card driven payment platform.

4. The electronic payment system according to claim 3, wherein when a timer controller receives a key in signal of the user for payment request, said electronic payment apparatus will turn from sleep mode to power operation mode;
wherein after a specified operation time or when the electronic payment apparatus does not receive the user's payment, said electronic payment apparatus will automatically turn off the power supply of a relevant power consumption unit and turn to sleep mode, to save power consumption;
and wherein said electronic payment apparatus further comprising:
a) an operation subunit, comprising a plurality of momentary buttons to select a desired service terminal; to select a service request; to select between a debit card, a credit card, and a prepaid card for said radio frequency identification card reader and writer to make payment; and to receive an electronic receipt in real-time;
b) a mode key subunit, for a maintenance personnel to create the mode key of said electronic payment apparatus formed by a sequence of button inputs; and for a maintenance personnel to turn on a WiFi module or a Bluetooth module in said wireless communication unit and its antenna set for maintenance operation.

5. The electronic payment system according to claim 2, wherein said charging management unit further comprises:
a first payment charging rule subunit, for calculating a required fee based on the service request entered by a consumer via said operation subunit and rules set by a service terminal provider; and
a service charging rule subunit, for calculating a required fee based on remote charging rules set by the service terminal provider

6. The electronic payment system according to claim 2, wherein said information management unit further comprising:
an apparatus display subunit, for instantly displaying a service selected by a consumer and fees associated with the service, and for displaying charged payment data on the display means after confirmation of the payment; and
a mobile phone communication setup interlinking subunit, for confirming that the consumer's electronic payment card is registered on the electronic payment card driven payment platform, for connecting the consumer's smartphone for communication, and for sending to the consumer payment information, wherein said payment information includes: the first payment electronic receipt obtained by means of the consumer's short message service (SMS), renewal request, and extended renewal request.

7. The electronic payment system according to claim 2, wherein said blacklist management unit manages and stores information including: bad debts; stolen, cloned or expired electronic payment card; mobile phone number and e-mail account of card holder, in a separate memory module.

8. The electronic payment system according to claim 7, wherein after said blacklist management unit checks against a blacklist, said transaction management unit confirms processing the payment, and generates transaction data information including: transaction number, electronic payment card number, expiry date of electronic payment card, transaction date, transaction time, purchased service request, service charge, electronic payment apparatus identifier, service terminal identifier, and remaining value of electronic payment card.

9. The electronic payment system according to claim 2, wherein said RFID reader and writer module stores and uploads the transaction data to the central payment operation control platform, said transaction data including: card type, card ID, card expiry date, transaction date and time, transaction amount, purchased service, the apparatus identifier, service terminal number, card balance value, and further comprises:
a) a debit card server payment application subunit, used to perform a whole debit payment transaction of a deposited amount, the cardholder shall pay based on the balance in the card when using the card, that is, overdraft is not allowed
b) a credit card server payment application subunit, used to perform a whole credit payment transaction within a credit limit, a card holder may spend by using the credit card within the credit limit and then repay later;
c) a prepaid card server payment application subunit, used to perform the payment transaction of the deposit amount and overdraft, the cardholder may deposit a certain amount of money according to the requirements of the card issuing institution, and when the deposit amount is insufficient for the payment, the card can be overdrawn within a defined credit amount.

10. The electronic payment system according to claim 3, wherein said main record unit further comprises:
a) a transaction record subunit, for managing and storing memory blocks separated from an internal memory, said internal memory stores transaction records and hashed results of the transaction records, wherein said transaction records comprise: card type, card number, card expiration date, transaction date, transaction time, transaction amount, purchased service time, service charge rate rule, said electronic payment apparatus identifier, remaining card value, and finally the transaction records are verified by hash verification codes, the transaction records shall be periodically uploaded to the central payment operational control platform for data analysis;
b) an operation record subunit, for managing and storing operation data information in the memory blocks separated from the internal memory, said operation data information comprises: the electronic payment apparatus downtime, date and time when the terminal service is not provided, date and time when the terminal service is free, recorded prescheduled or abnormal restart time, failed transaction records resulted from the cards in said blacklist, cumulative daily operating hours, and battery low notification;
c) a maintenance record subunit, for managing and storing maintenance information in the memory blocks separated from the internal memory, and for maintaining the maintenance information which comprises diagnosis and repair logs, and date of battery replacement.

11. The electronic payment system according to claim 1, wherein said security management unit manages a plurality of encryption and decryption keys generated by the key management unit by using a main key; wherein said security management unit further comprises:
a) a SAM decryption key storage subunit, for storing the electronic payment apparatus identifier, a first decryption key (A), and a key generation algorithm; wherein said key generation algorithm generates a fourth decryption key (D) using said first decryption key (A) and a second decryption key (B) that is embedded in said encryption key storage subunit;
b) an embedded encryption and decryption keys storage subunit, for storing the second decryption key (B) and a third encryption key “C” that is stored in an encrypted chip and cannot be disassembled nor cracked from said electronic payment apparatus;
c) an Advanced Encryption Standard (AES) decryption algorithm subunit, for decrypting data and system settings sent to the said electronic payment apparatus from said central payment operation control platform using the security check of the fourth decryption key (D) at AES; wherein said data and system settings include:
(i) standard charge rate,
(ii) progressive charge rate, and
(iii) daily operational information, said daily operational information includes: a timetable of a plurality of operations, and the charge rates for different terminals, operation time, an operation selection mode, a restricted service mode, a free service mode, a grace period for remaining time, a non-cumulative time, on/off encryption technology and the user operation steps; wherein said system settings updates:
synchronizing time setting,
upload and download time setting of the radio frequency identification reader and writer files,
radio frequency identification reader and writer temporary blacklist download time setting,
radio frequency identification reader and writer data integration time setting, and
transaction data uploading time interval setting,
d) an Advanced Encryption Standard (AES) encryption algorithm subunit, for encrypting and uploading the information data files using the third encryption key (C) by the AES security check for the data sent from said electronic payment apparatus to said central payment operation control platform, said information data files comprise:
said transaction data information,
said security and environmental information, and
said operational data information and the maintenance data.

12. The electronic payment system according to claim 2, wherein said storage management unit stores the records of the electronic payment apparatus in a time-sequential manner in a linear buffer mode in the storage block separated from the internal memory, wherein each transaction data is generated and recorded based on the transaction details, and its SHA-1 (cryptographic hash function) is generated and used, which preserves the integrity and authenticity of each transaction data, and also enhances the reliability of the data transmission process from the electronic payment apparatus to the central payment operation control platform and ensures the correctness of transaction data for subsequent clearance and settlement, wherein said electronic payment apparatus further comprising:
a) a real-time comprehensive backup subunit, which stores all data of the storage means for backup purposes, including the overall transaction table, each transaction record, bad debt card blacklist, operational data, maintenance information; whenever there is data loss in the main record area, the information can still be recovered from the real-time comprehensive backup area;
b) a whole set upload record backup subunit, for storing the whole data set of the real-time comprehensive backup area as a backup copy, this data set is stored in this area until the data set has been successfully uploaded to the central payment operation control platform, and preparing for uploading the next data set; in case that a data set collected by the control platform is lost or the data set can't be uploaded to the control platform due to network and other problems, the original data set still has to be uploaded to the control platform control from the backup area until a special password is used to control and activate; the data backup copy being transmitted to the control platform confirms that the data set that has been recorded in the control platform database is not repeatedly recorded.

13. The electronic payment system according to claim 2, wherein said communication management unit further comprises:
a) a 3G/4G operation support subunit, to remotely communicate with a plurality of said electronic payment apparatus in an area covered by the telecommunication network, and to upload and download the information data files;
b) a Zigbee short-range wireless network support subunit, to provide a master/slave mode in a range of several-tens meters to form a point-to-point communication network of master/slave apparatus; the master apparatus may actively read the data transmitted from the slave apparatus, the slave apparatus is simply used as a wireless link in the network to other slave apparatus, and can form real network for access and management; once an abnormal problem is presented in the wireless network, said electronic payment apparatus can automatically switch from the master mode to the slave mode, initiate the master apparatus in the closest distance, transmit the data to the said master apparatus and send it back to the control platform;
c) a WiFi operation support subunit, for emergency backup in remote areas or areas that are not covered by telecommunications network, to enable an appropriate communication port to connect to a handheld data apparatus, allowing operator to utilize mobile applications (supporting android/iOS) within the handheld operating means for short-distance maintenance operations or to collect information uploaded and downloaded by the electronic payment apparatus;
d) a Bluetooth operation support subunit, having same functions as those of the WiFi operation support subunit and the Zigbee operation support subunit, used as a backup wireless network transmission;
e) an electronic receipt generating subunit, for the consumer to receive an electronic receipt via a financial card driven payment platform using a mobile phone equipped with short-range wireless communication.
f) a service information reading subunit, for the consumer to receive the electronic service information via the electronic payment card driven payment platform using the mobile phone equipped with short-range wireless communication.
g) an overtime penalty ticket generating subunit, for an operator to use the hand-held operating means to issue a penalty ticket at a short range to consumer who used the service exceeding the time limit.
h) a dial-up connection subunit, to provide a temporary service function, and the control platform can dial a particular telephone number of the electronic payment apparatus; said electronic payment apparatus then connects the call and verifies the telephone number transferred to said control platform, after that verifies said call is coming from said control platform; then the electronic payment apparatus will perform a specific operation such as remote recharging, document downloading, etc., by connecting to the control platform via HTTPS and sending status flags; the dial-up connection subunit also allows the consumer to make a call to the electronic payment apparatus using the financial card driven payment platform, to add renew fees.

14. The electronic payment system according to claim 2, wherein said monitoring engine unit is connected with each component of the electronic payment apparatus and monitors the operation states of all the components, and said electronic payment apparatus further comprises:
a) a module running status reporting unit, which extracts the current operation state of each component in the electronic payment apparatus, establishes a fault log and sends information of the fault states to the designated recording location; and
b) an automatic repair unit, which, in accordance with the predicted improper operation, repairs the fault module without interfering with the system applications or business applications.

15. The electronic payment system according to claim 2, wherein said management service unit further comprises:
a) an upgrading subunit, used to upgrade the electronic payment apparatus firmware or software via a local port or a remote network;
b) a reporting subunit, used to send the current operation state of each module to the operator of the electronic payment apparatus;
c) a parameter setting subunit, for the operator to enter the relevant parameters of each module within the electronic payment apparatus, to set the system settings; and
d) an extract download data subunit, for the operator to download and store the update documents, settings and firmware upgrades of all RFID readers and writers from the central payment operation control platform periodically.

16. The electronic payment system according to claim 2, wherein said operation notification unit issues a notification signal to the consumer according to the operation state, wherein said electronic payment apparatus further comprises:
a) a sound notification subunit, to notify the operation state to the consumer by sound signal, wherein the sound signal comprises making a sound when a button is pressed or a card is swiped, indicating a successful transaction;
b) a flashing notification subunit, to indicate the operation state to the consumer by light signal; and
c) a display control subunit, showing the rental time, timer or electricity meter of battery status, information relating to the operating procedures, and is capable of displaying other relevant information including weather information sent by the central payment operation control platform to the display means.

17. The electronic payment system according to claim 2, wherein said hybrid power system management unit provides power to the whole electronic payment apparatus, and supports a plural sets of disposable alkaline battery packs, rechargeable battery packs, backup rechargeable battery and a hybrid power supply circuit thereof, wherein said electronic payment apparatus further comprises:
a) a battery pack state of charge subunit, which is used to accurately estimate the charging state of the battery packs, i.e. the remaining battery power, to ensure that the charging state is maintained within a reasonable range, to prevent damage to the battery due to over discharge, and hence to predict in real time how much energy is remaining in the energy storage battery, or to predict the charging state of energy storage battery.
b) a battery operation subunit, which is used to calculate the charging state of a multiple battery packs in sequence or comparatively, to automatically make equalization control and achieve a low power consumption; whenever the battery pack is under voltage, the power is about to run out or the power is cut off abruptly, another set of battery packs will feed the power to the direct circuit, without switching time; the battery packs can feed power in accordance with a predetermined sequence, and hence the maintenance staff would not easily change the wrong batteries.
c) a back-up rechargeable battery power supply subunit, which is used to provide a back-up electricity power; when the primary alkaline battery or the rechargeable battery needs to be replaced, the display means and the notification operation apparatus can still run for a short period of time to let the maintenance staff know that the whole apparatus is still running, to avoid loss of any storage data.

18. The electronic payment system according to claim 2, wherein said electronic payment card driven payment by phone platform (PPP) provides a payment platform application program, which offers further convenience for a registered user, supporting both Android and iOS systems and supporting a variety of different payment clearance institutes, without having to physically return to the electronic payment apparatus to renew service time of a paid service, when a registered user finishes at a first time using his/her registered electronic payment card on the apparatus to execute, confirm and pay the purchased service, the payment record of said electronic payment card is uploaded to the control platform, and the user's electronic payment card number can be found by the control platform from the payment record and the paired apparatus will be found automatically to renew the service time, without the user having to enter the apparatus identifier into the electronic payment card driven payment platform so as to avoid mistake in entering the apparatus identifier, the registered users may choose to pay a second renewal service fee by using an interactive voice response system (IVRS) from an ordinary phone, a short message service, or by a mobile application on a smartphone, so that the purchased service request is accurately reflected in the apparatus, the electronic payment card driven payment platform is configured that the registered user may pay from one or more of the apparatus and avoid abusing the service terminal;
wherein when the service time expires, pairing is needed between the registered user and the registered electronic payment card, the user can receive expiry information via a voice call (via IVRS processing), a short message service (SMS) or a mobile application on a smartphone, then the registered user can pay for more service time by using the above means without having to return to the apparatus, the purchased service can be accurately reflected in the apparatus when the electronic payment procurement process is successfully completed, then the payment clearance process will be performed on the apparatus specified by the electronic payment card driven payment platform.

19. A method of electronic payment using the electronic payment system according to claim 1, comprising:
a) registering user personal data on the electronic payment card driven payment platform by means of its mobile application, comprising one or more contactless type electronic payment cards, renewing electronic payment card, renewing financial apparatus, renewing phone number and email account, a dedicated account number of the electronic payment card driven payment platform will be assigned to this user;
b) paying for service charge with a registered electronic payment card via the contactless type electronic payment card;
c) linking the electronic payment card to another electronic payment card for registration, wherein linking comprises inputting credit card number on the mobile application and paying from the credit card;
d) the server of the electronic payment card driven payment platform receives the electronic payment card of the registered user, if any pending registered user does not confirm renewing fee, the next user who need to renew will override the functions of the PPP, and the PPP will determine if the electronic payment card is registered or not;
e) the apparatus communicates with the electronic payment card driven payment platform at the central data center via a telecommunication means, wherein the telecommunication means comprise fixed-network, telephone line, short message, 2G, 3G, and 4G.
f) if it is confirmed that the registered user is already connected to the registered payment card on the electronic payment card driven payment platform, the electronic payment card driven payment platform sends out a payment message (via voice call (IVRS), short message service (SMS), and/or smart phone notification message) to the mobile phone of the registered user;
g) confirming to the service message sent by the electronic payment card driven payment platform by voice communication, short message or mobile application, so as to confirm the corresponding service of the smart service terminal means;
h) if the registered user confirms to use the service of the electronic payment card driven payment platform: the registered user selects between: Option (1) accept the automatically assigned timeslot or the automatically extended service time before the current service time expires; or Option (2) the registered user considers to confirm accepting to renew the service time of the designated smart service terminal apparatus by telephone service, and to accept receiving an alert message of a pre-defined grace period; or Option (3) the registered user voluntarily logs in the electronic payment card driven payment platform;
i) if the registered user selects Option (1), the service selected by the registered user is renewed remotely; after the registered user confirms to renew the service, an exact payment amount is paid through the electronic payment card driven payment platform;
j) if the registered user uses a credit card/a prepaid card to renew the service, the transaction of renewing service is updated directly on the electronic payment card driven payment platform;
k) if the registered card is a debit card, the user uses the mobile phone connected to an apparatus which support debit card payment to perform payment in real time;
l) if the registered user selects Option (2), an alert message will be sent to the registered user before a pre-defined grace period or the service expires;
m) if the registered user selects Option (3), choosing to confirm and renewing the service request directly;
n) performing the payment processes of steps j) to k);
o) the registered user confirms the required service selected to perform service renewal remotely;
p) the electronic payment card driven payment platform updates the required service renewal of the central payment operation control platform, and updates the designated EPM via mobile communication network; and
q) finally, the user's mobile phone receives a notification message via voice call (IVRS), short message service (SMS) and/or smartphone application to make the final confirmation on the transaction.
